(19) United States
(12) Patent Application Publication
(10) Pub. No.: US 2011/0170706 A1
(43) Pub. Date: Jul. 14, 2011

(54) Feedback-Killing Speaker System

(75) Inventor: Miin-Lieh Wang, Taipei (TW)

(73) Assignee: PHONIC CORPORATION, Taipei (TW)

(21) Appl. No.: 12/942,208

(22) Filed: Nov. 9, 2010

(30) Foreign Application Priority Data
Jan. 14, 2010 (TW) 099200758

(51) Int. Cl. H04B 15/00

(52) U.S. Cl. 381/93

(57) ABSTRACT

A speaker system includes an interface, a powered mixer, a first amplifier, a switch, a feedback killer and a second amplifier. The interface can receives an audio signal from a sound source. The powered mixer adjusts the audio signal by amplifying some of the frequencies of the audio signal. The first amplifier preliminarily amplifies the adjusted audio signal. The switch connects the first amplifier to the feedback killer if the amplitudes of any frequencies of the preliminarily amplified audio signal are outside a predetermined range and otherwise connects the first amplifier to the second amplifier. If the first amplifier is connected to the second amplifier, the second amplifier amplifies the gain of the preliminarily amplified audio signal. If the first amplifier is connected to the feedback killer, the feedback killer executes feedback killing on the preliminarily amplified audio signal before sending it to the second amplifier.

### CROSS REFERENCE TO RELATED PATENT APPLICATIONS

This application claims priority from Taiwan Patent Application No. 099200758, filed in the Taiwan Patent Office on Jan. 14, 2010, entitled “Feedback-Killing Speaker System,” and incorporates the Taiwan patent application in its entirety by reference.

### TECHNICAL FIELD OF THE PRESENT DISCLOSURE

The present disclosure relates to a speaker system equipped with a feedback killer and, more particularly, to a speaker capable of spreading audio signals while reducing feedback, echo, interference and noise.

### DESCRIPTION OF THE RELATED ARTS

A microphone is used to turn a user's voices into electronic signals while a speaker is used to turn the electronic signals back into voices. The speaker spreads sonic waves corresponding to the electronic signals or the voices. When the speaker is located near the microphone, the sonic waves vibrate the microphone and entail undesirable feedback, echo, interference and noises.

Therefore, a worker compares frequency responses generated by a speaker with the optimal expected sound effects after locating the speaker in a cabinet. Moreover, the worker adjusts resistors and capacitors of an equalizer of the speaker to achieve a proper gain to effectively adjust the frequency response of the speaker. Therefore, the worker makes the speaker provide the optimal sound effects in normal people's range of frequency, 20 Hz to 20 KHz.

Conventionally, when equalization tuning of the speaker is conduced for various frequencies, the sound effects at various sampled frequencies are tested with a testing device. The resistors and the capacitors of the equalizer are adjusted manually. Thus, optimal frequency responses are produced. However, such manual adjusting is time-demanding and exhausting. When a new speaker is located in the cabinet instead of the speaker, such time-demanding and exhausting manual adjusting must be done again. A worker might get tired of it and take it lightly so that the quality of the adjusting would be jeopardized. At best, the quality of the adjusting is different one worker from another. The quality of the adjusting cannot be kept above a level.

As discussed above, the making of a speaker system is inconvenient and not without problems. Although the equalizer is used to alleviate the problems, it is still troublesome to locate numerous parts within the cabinet. Therefore, the cost is high and the competitiveness is weak.

The present disclosure is therefore intended to obviate or at least alleviate the problems encountered in prior art.

### SUMMARY OF THE PRESENT DISCLOSURE

The primary objective of the present disclosure is to provide a speaker system capable of adjusting frequency response to the optimal value.

To achieve the foregoing objective, the speaker system includes an interface, a powered mixer, a first amplifier, a switch, a feedback killer and a second amplifier. The interface can be connected to a sound source so that the interface receives an audio signal from the sound source. The powered mixer is connected to the interface so that the powered mixer adjusts the audio signal by amplifying some of the frequencies of the audio signal. The first amplifier is connected to the powered mixer so that the first amplifier preliminarily amplifies the adjusted audio signal. The switch connects the first amplifier to the feedback killer if the amplitudes of any frequencies of the preliminarily amplified audio signal are outside a predetermined range and otherwise connects the first amplifier to the second amplifier. If the first amplifier is connected to the second amplifier, the second amplifier amplifies the gain of the preliminarily amplified audio signal. If the first amplifier is connected to the feedback killer, the feedback killer executes feedback killing on the preliminarily amplified audio signal before sending it to the second amplifier.

Other objectives, advantages and features of the present disclosure will become apparent from the following description of the attached drawings.

### BRIEF DESCRIPTIONS OF THE DRAWINGS

The present disclosure will be described via detailed illustration of the preferred embodiment referring to the drawings.

FIG. 1 is a perspective view of a speaker system according to the preferred embodiment of the present disclosure;

FIG. 2 is a block diagram of a circuit used in the speaker system shown in FIG. 1; and

FIG. 3 is a detailed block diagram of a feedback killer used in the circuit shown in FIG. 2.

### DESCRIPTION OF THE PREFERRED EMBODIMENT

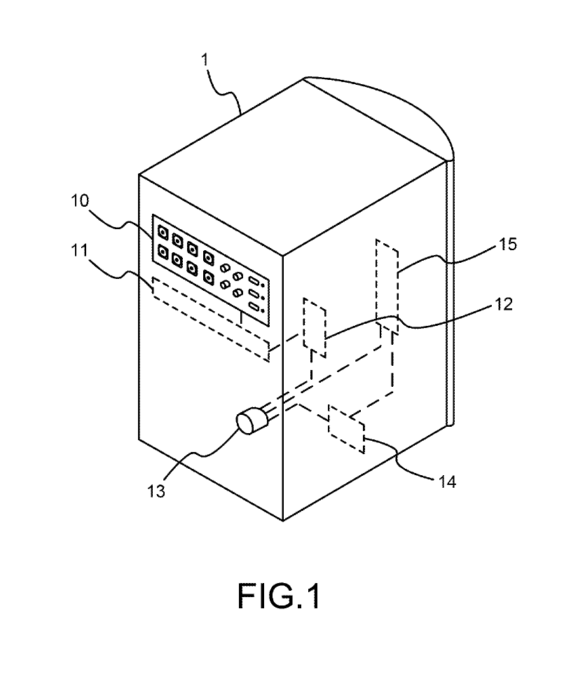

FIG. 1 shows a speaker system 1 which includes a cabinet, an interface 10, a powered mixer 11, a first amplifier 12, a switch 13, a feedback killer 14, and a second amplifier 15 according to the preferred embodiment of the present disclosure. The interface 10 and the switch 13 are located on a rear face of the cabinet. The powered mixer 11, the first amplifier 12, the feedback killer 14 and the second amplifier 15 are located within the cabinet.

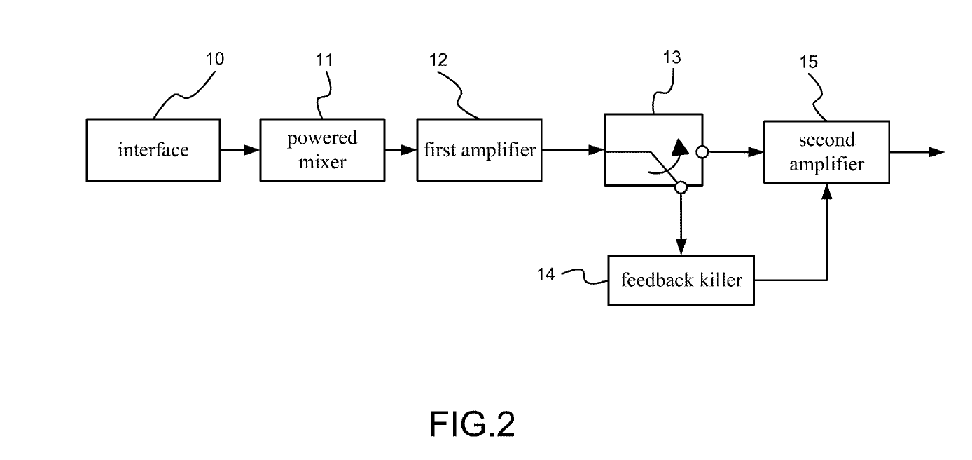

FIG. 2 shows an output terminal of the interface 10 which is connected to an input terminal of the powered mixer 11. An output terminal of the powered mixer 11 is connected to an input terminal of the first amplifier 12. An output terminal of the first amplifier 12 is connected to an input terminal of the switch 13. An output terminal of the switch 13 is connected to an input terminal of the feedback killer 14 or an input terminal of the second amplifier 15. An output terminal of the feedback killer 14 is connected to the second amplifier 15.

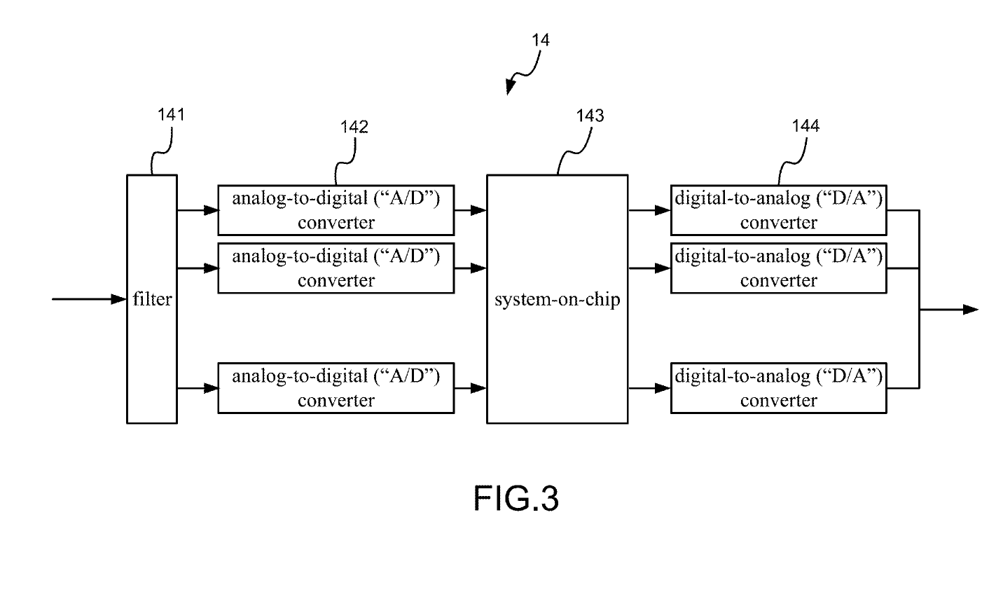

FIG. 3 shows the feedback killer 14 which includes a filter 141, several analog-to-digital (“A/D”) converters 142, a system-on-chip 143 and several digital-to-analog (“D/A”) converters 144. The filter 141 is connected to the A/D converters 142. The A/D converters 142 are connected to the system-on-chip 143. The system-on-chip 143 is connected to the D/A converters 144.

In operation, a sound source is connected to the interface 10. An audio signal, having a plurality of frequencies, is provided to the interface 10 from the sound source. The audio signal is sent to the powered mixer 11 from the interface 10. In the powered mixer 11, some frequencies of the audio signal are adjusted, i.e., amplified. In the powered mixer 11, frequencies in treble, contralto, base, infrasound or all of the ranges are amplified. The adjusted audio signal is sent to the first amplifier 12 from the powered mixer 11. In the first amplifier 12, the adjusted audio signal is amplified preliminarily.

The switch 13 connects the first amplifier 12 to the feedback killer 14 if the amplitudes of any frequencies of the preliminary amplified audio signal are outside a predetermined range. Otherwise, the switch 13 connects the first amplifier 12 to the second amplifier 15. When the first amplifier 12 is connected to the second amplifier 15, the preliminarily amplified audio signal is sent to the second amplifier 15 from the first amplifier 12. In the second amplifier 15, the gain of the preliminarily amplified audio signal is amplified before complete output.

When the first amplifier 12 is connected to the feedback killer 14, the preliminarily amplified audio signal is sent to the feedback killer 14 from the first amplifier 12. The preliminarily amplified audio signal is reduced in the feedback killer 14 before it is transferred to the second amplifier 15. The reduced audio signal is amplified in the second amplifier 15 before the complete output.

When the first amplifier 12 is connected to the feedback killer 14 by operating the switch 13, the preliminarily amplified audio signal is sent to the filter 141 from the first amplifier 12. The frequencies with the amplitudes outside the predetermined range are sent to the A/D converters 142 from the filter 141. Each of the A/D converters 142 is used to convert analog signals in a specific range of frequencies into digital signals that are sent to the system-on-chip 143.

In the system-on-chip 143, feedback killing is conducted for the frequencies with the amplitudes outside the predetermined range. The gain of the first amplifier 12 is reduced. The amplitude of the audio signal is confined within a predetermined range. Then, the audio signal is sent to D/A converters 144 from the system-on-chip 143. Each of the D/A converters 144 is used to convert digital signals in a specific range of frequencies into analog signals. Then, the audio signal is sent to the second amplifier 15 from the D/A converters 144.

As discussed above, the feedback killer 14 is used in the speaker system of the present disclosure. The feedback killer 14 controls the gain of the first amplifier 12. Thus, the amplitude of the audio signal is confined in the predetermined range. Therefore, avoided is excessive output that would otherwise occur when the input of the audio signal is loud. Feedback, echo, interference and noises are reduced. The audio signal can be adjusted to optimal frequency responses while no worker has to use any instrument to repeatedly test sound effects for various ranges of frequencies and adjust resistors and capacitors of an equalizer for a long period of time.

The present disclosure has been described via the detailed illustration of the preferred embodiment. Those skilled in the art can derive variations from the preferred embodiment without departing from the scope of the present disclosure. Therefore, the preferred embodiment shall not limit the scope of the present disclosure defined in the claims.

What is claimed is:

1. A speaker system comprising:
an interface;
a powered mixer;
a first amplifier;
a switch;
a feedback killer; and
a second amplifier;
wherein, when connected to a sound source, the interface receives an audio signal having a plurality of frequencies from the sound source;
wherein the powered mixer is connected to the interface to adjust the audio signal by amplifying some of the frequencies of the audio signal;
wherein the first amplifier is connected to the powered mixer to preliminarily amplify the adjusted audio signal;
wherein the switch connects the first amplifier to the feedback killer when amplitudes of any of the frequencies are outside a predetermined range, otherwise the switch connects the first amplifier to the second amplifier;
wherein the second amplifier amplifies a gain of the preliminarily amplified audio signal when the first amplifier is connected to the second amplifier; and
wherein the feedback killer executes feedback killing on the preliminarily amplified audio signal before sending the preliminarily amplified audio signal to the second amplifier when the first amplifier is connected to the feedback killer.

2. The speaker system according to claim 1, wherein the feedback killer includes a filter, analog-to-digital converters connected to the filter, a system-on-chip connected to the analog-to-digital converters, and digital-to-analog converters connected to the system-on-chip.

3. The speaker system according to claim 2, wherein the frequencies of the preliminarily amplified audio signal are sent to the analog-to-digital converters from the filter;
wherein each of the analog-to-digital converters converts analog signals in a respective range of frequencies into digital signals that are sent to the system-on-chip;
wherein the system-on-chip executes feedback killing to reduce at least amplitudes of the frequencies outside the predetermined range to reduce a gain of the first amplifier to confine an amplitude of the audio signal; and
wherein each of the digital-to-analog converters converts digital signals in a respective range of frequencies into analog signals before sending the audio signals to the second amplifier.

4. The speaker system according to claim 1, wherein the powered mixer amplifies frequencies in treble, contralto, base, and infrasound.
